(19) United States
(12) Patent Application Publication
(10) Pub. No.: US 2009/0263779 A1
(43) Pub. Date: Oct. 22, 2009

(54) METHOD AND SYSTEM OF PROVIDING A COLLEGE LEVEL COURSE FROM A THIRD PARTY PROVIDER TO A COLLEGE

(76) Inventor: Carolyn T. White Nye, Raleigh, NC (US)

Correspondence Address: PASSE' INTELLECTUAL PROPERTY, LLC, 1717 BRASSFIELD RD., RALEIGH, NC, 27614, US

(21) Appl. No.: 12/104,084

(22) Filed: Apr. 16, 2008

(51) Int. Cl. G09B 7/00

(52) U.S. Cl. 434/362

(57) ABSTRACT

The present invention relates to a system and method of providing a college level course from a third party provider to a college. The present invention allows the college to offer the course to its students as if the course was produced and offered by the college itself rather than the third party provider. The course is preapproved and then the college can provide the student grades from the third party provider as if the course was a regular course from the college.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to the provision of classes to colleges with a small enrollment in the class. Particularly, the present invention relates to a system and method whereby a college can provide its students a particular class even if enrollment is otherwise inadequate in size or if there is no internally available teacher within the given college to teach the course.

2. Description of Related Art

Large colleges and universities typically have the advantage of while tending to be impersonal, they can provide all the courses needed for the particular degree program as well as many optional courses. Smaller colleges offer personalized teacher interactions, smaller campuses and class sizes, and a more interactive college experience. They suffer in that frequently, courses need to be cancelled or not offered in the first place due to inadequate enrollment in a given semester or quarter. Further, the variety of courses they can offer in a given curriculum is often limited to just a few optional courses or in some cases, just to core classes. Even further, smaller colleges may not have the faculty depth to offer all the classes necessary for a detailed degree.

Students at smaller colleges frequently must, at the last minute, enroll in off campus courses or courses at different colleges to ensure that they complete required courses in a timely manner to prevent delay in receiving their degree. Often, this further gets complicated as delays in course completion and grade delivery to the college often occur. It is not uncommon that a particular course ends up unacceptable to the student's own college, for example, because the course does not meet either teacher or accreditation requirements necessitating repetition of the course.

More recently, the availability of computer based courses has given the student seeking outside courses a wider variety of courses to choose from when deviating from those offered by the enrolled college. However easy these are to enroll in, they are still not part of the college curriculum and need to have grades transferred and accepted like other off-line college courses. These courses are still subject to the same problems as are other courses the student can take.

In spite of there being some drawbacks to online courses in general, for college students, a number of methods and systems for delivering course material over a computer or internet have been developed. For example, in U.S. Pat. No. 6,155,840 issued Dec. 5, 2000 to Alfred Sallette, there is described a system and method for distributed learning including a learning server coupled to a presenter and audience computer system via a network such as the internet.

In U.S. Pat. No. 6,397,036 issued May 28, 2002 to Thean and Whitley, there is disclosed a collaborative learning system method and computer program product which permits live, real time interaction between the audience and is presented in a controlled learning environment. In U.S. Pat. No. 6,898,411 issued May 24, 2005 to Ziv-el et al., there is disclosed a teaching and learning method and system that communicates exercises, pages and questions related thereto from a teacher's computer to a student's computer. Also, in U.S. Pat. No. 7,013,325 issued Mar. 14, 2006 to Vivian and Hjelle, there is disclosed a system and method for providing a specialized learning curriculum to users over a computer network. At least one server computer associated with an education content provider hosts a learning center web site that solicits and receives personal information from users regarding preferences.

It would be extremely useful for small colleges, and most likely colleges in general, if there were a way or a means or a system to offer their students classes without fear of needing to cancel them or not be able to offer them in the first place because of lack of appropriate teachers.

### BRIEF SUMMARY OF THE INVENTION

The present invention offers as an object of the present invention, a means and system to provide colleges with courses they can offer through their catalog or curriculum without fear of the number needed to enroll while still meeting their criteria for the class.

It is also an object of the present invention to be able to provide a method and system for colleges to offer classes directly to students that the colleges wouldn't otherwise be able to offer.

In general, the method and system of the present invention relates to a system provider who hires teachers with a predetermined criterion and puts together a series of college level courses. The service provider then loads the list of courses to the internet where a plurality of colleges may choose one or more courses to offer their students. The college offers the course to the students and enrolls the students in their normal course of enrollment. The college gives the list of students, even if just one student, and then the service provider provides the class to the one or more students at the one or more colleges over the internet. After completion of the course by the student, the service provider provides student grades to the colleges who include the grades in the student's normal grades. In one embodiment, the service provider provides the course to each student over the internet in a manner that the course appears to come directly from the student's own college.

According to one embodiment of the present invention, the invention relates to a method of providing over the internet to a plurality of colleges, a class for students in the plurality of colleges regular curriculum comprising the steps of:
a) offering a college level course from a service provider to a plurality of colleges over the internet;
b) receiving from one or more of the plurality of colleges acceptance of the course;
c) the service provider receiving information from each of the one or more of the plurality of colleges who accepted, information on the students to receive the class;
d) storing the information on the students to receive the class on at least one server computer;
e) generating the class and delivering the class to the internet;
f) providing an internet interface to each of the students in order for the student to receive the course from the internet wherein the interface each student receives indicates that the class is coming from the student's college.

Another embodiment of the invention is a system for providing a class to a plurality of colleges over the internet for inclusion in their curriculum comprising:
a) at least one server computer associated with an independent college course provider connected to the internet;
b) one or more computers associated with each of the plurality of colleges each computer connected to the internet;
   wherein at least one server computer incorporates an application for offering the class to the plurality of colleges over the internet and accepting at least one of the colleges for the course, for receiving and storing a list from the accepting colleges of the students who will take the course, and for providing the class to the list of students over the internet; and
   wherein at least one of the servers is capable of presenting an interface to each student indicating the course is from the student's college.

Yet another embodiment of the invention, there is provided a system for providing one or more colleges a class for inclusion in its curriculum comprising:
a) a college course providing entity having a predefined contractual interface that specifies the terms by which a college may access a course provided by the college course providing entity; and
b) the college course providing entity functioning according to the predefined contractual interface to prepare a college course and deliver the course to the college as part of its curriculum.

### BRIEF DESCRIPTION OF THE DRAWINGS

FIG. 1 is a flow chart of the process of the service provider.

FIG. 2 is a flow chart of the invention process from the perspective of a college.

FIG. 3 is a relationship diagram of the parties to the present invention.

FIG. 4 is a relationship of the parties and the internet in the present invention.

FIG. 5 is a diagram of the relationship of teachers and students in the present invention.

FIG. 6 is the relationship diagram of a student and the college in the present invention.

### DETAILED DESCRIPTION OF THE INVENTION

The present invention relates to a method of providing colleges courses they can offer through their regular college offering, yet be maintained and managed by an independent third party and, thus eliminate the need for any transfer-credit process normally encountered by off-campus internet based coursework.

While this invention is susceptible of embodiment in many different forms, there is shown in the drawings and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein the term “college” refers to colleges, universities, community colleges and the like which offer “higher education” to their students. These organizations have in common a course “curriculum” that is a list of college level courses that the student can choose from to take during their studies at the institution that are administered and approved by the college. All courses on that list of curriculum are administered normally by the college and grades received by the student directly from the college. As noted above, third party courses and curriculum are normally taken independent of the college and then the student must apply for acceptance by the college.

In the present invention when one or more college desires to add a college level course to its curriculum, it would go to the internet and look at a list of courses offered by the service provider of the present invention. The service provider is also referred to herein as the college course providing entity. Each college may accept any courses it then desires to add to its curriculum, and the internet portion of the invention can be accomplished by any convenient method. Such methods could be a checkout basket, e mail notification, preregistration, prepayment or the like. In general, the service provider will engage one or more colleges into a predefined contractual relationship or interface and, while the internet is one embodiment of the invention, other embodiments are possible and within the scope contemplated herein.

Once the service provider has offered and one or more colleges accepted a course, the college would offer the course to students in its regular curriculum offering and sign up students. Once it has accepted students whether one or a thousand, it reports the information to the service provider. The service provider then stores all the desired information on a server computer so that only authorized students may take the course from the service provider.

Once the class is prepared or generated, the service provider can provide information of the class to the college for distribution to the students or the service provider can provide information of the class directly to students in a manner that it appears to come directly from the college.

The service provider prepares the class to be delivered in a normal manner, e.g. hires a teacher (either as an employee or independent contractor, (i.e. a teaching agent of the service provider), prepares the lesson plan and then either pre-records or otherwise prepares to regularly deliver live the course over the internet. Delivery of course material over the internet is well known for both live and recorded classroom type situations. These courses can be interactive or just like watching a video tape as desired. Each student however will interface as if taking a course on the internet from their own university. The main idea here though is that the contractual interface between the service provider and the college is to deliver the course to the college as part of its curriculum. Other methods of indicating it is part of the curriculum are contemplated and the internet interface is just one of such an embodiment.

The service provider will have one or more server computer that is connected to the internet. This can be the set up to provide the course to the one or more college. It can also be the computer to provide the interface for colleges to sign up for courses from the service provider. Likewise, each college will have to have at least one computer for establishing an internet connection and finding and signing up courses from the independent college course provider that is connected to the internet.

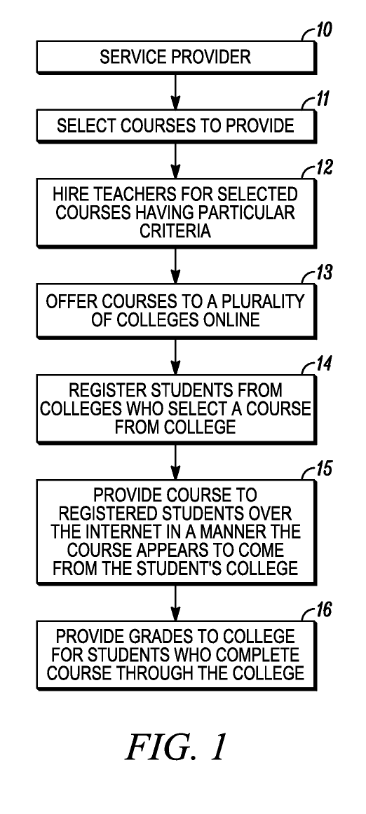

Now referring to the drawings FIG. 1 is a flow chart of an exemplary embodiment of service provider activities. The service provider 10 is the independent (of the colleges) organization that will be offering colleges college level courses through a college internal curriculum. The service provider 10 decides what courses it determines that it can market to a college from courses that a college normally provides or courses that it determines colleges may have an interest in. Since smaller colleges are more likely to have trouble finding a large number of students available for some types of courses to make them cost effective to offer, courses that appeal to colleges and students at these types of colleges would be an embodiment of the courses to select from. Once the service provider 10 determines what it can offer, it selects courses to offer 11 to colleges on its internet web site.

Once the courses have been selected 11, the service provider 10 will hire 12 (or continue to pay or the like) teachers that can teach the course. Each teacher must have particular criteria when hired. The criteria will be consistent to the normal criteria colleges would use in hiring teachers at their own college consistant with national or local accreditations requirements. So, in one embodiment, teachers at professor or assistant professor levels can be hired on an employee or contract basis to teach a particular course or courses. This step in one embodiment is omitted until colleges actually sign up for the course and provide students for the course so that teachers are not hired and then no course provided.

Next, the service provider 10 takes the courses with the details and offers the course on line 13 (internet) in a manner that colleges can view the courses. Since only certain types of organizations can make use of the courses, the availability of viewing the internet course offerings can be open to anyone or can be a closed system where colleges must register first before being allowed access to the site to view and pick classes. By offering them online, colleges can then pick the courses they want based on filling in courses from the curriculum they need and the ability to review the teacher credentials or any other criteria that the service provider provides for the course. The college in this step can accept and register for courses it will offer.

Once the college has signed up for a course, it will include it in its curriculum offering and sign up students. Once registered, the colleges will report the student list back to service provider 10 and register the students to receive the course 14. The registered students will then receive the course over the internet 15 and do it in a manner that they are receiving the course from the student's own college.

Once the course is completed, the service provider 10 provides each student's grades directly to the college so that students may receive their grades from the college and not a third party provider.

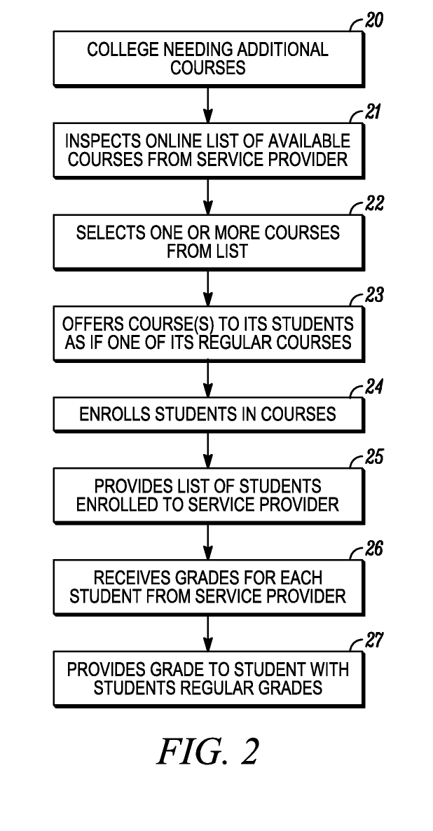

FIG. 2 is a flow chart of activities from the perspective of a college needing additional courses 20 for its curriculum. The college 20 goes on the internet to the service provider 10 (from FIG. 1) and inspects the list of available courses 21. The college 20 looks over the list and sees if there are courses that match its needs and if there are any courses that it determines are of interest. The college 20 then can review the teacher and course and make sure it meets its needs and accreditation requirements. The college 20 then selects one or more courses from the list 22. The college signs up online or any manner in which the service provider 10 has provided online to the college 20.

Once the college 20 has selected the courses 22 from the list, it can then include the courses in its curriculum offering and thus offer the courses to its students as one of its regular courses 23. The college 20 can do this by just listing the course in its course book, online list or the like as consistent with the college's normal method of offering classes to students. The college then enrolls students in the courses 24 offered by the service provider. Once the sign-up period for courses has ended, the college will provide the list of students enrolled in the courses 24 to the service provider 10. The service provider can enter the list of students into its database for inclusion in the course when it starts.

The service provider then takes care of the course delivery as depicted in FIG. 1 leaving nothing to do for the college during this period of time. Once the course is completed, the service provider 10 sends out grades and the college receives the grades 26. At this point, no student has received the grades. Once the college receives grades from the service provider, the college can include the grades with student's regular grades and provides the grade to the student along with the courses grades from the regular college courses 27.

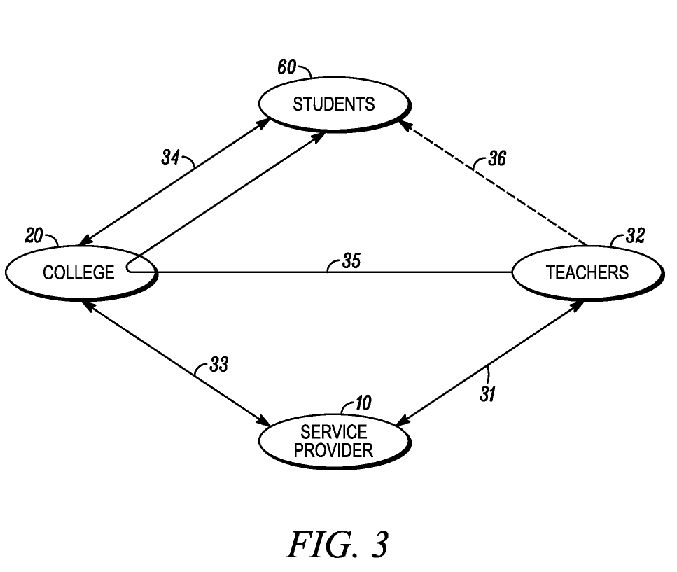

In FIG. 3 there is shown the general relationship between the parties to the present invention. Service provider 10 is shown to have both a direct relationship between the teachers 32 it hires 31 and each college 20. The service provider 10 hires the teachers 32 and offers courses and provides courses to colleges 20. College 20, on the other hand, has a direct relationship with the service provider 10 and its own students 60 via arrow 33 and 34. The college 20 offers courses to students 60 including those courses it will be using from service provider 10. The teachers 32, on the other hand, while they provide the class course to students represented by dotted line 36, actually provide the course in such a way that it appears to come from the college. This line 35 coming from teachers 32 goes to the college 20 and then to the students 60 representing the appearance the relationship has with the teachers and students.

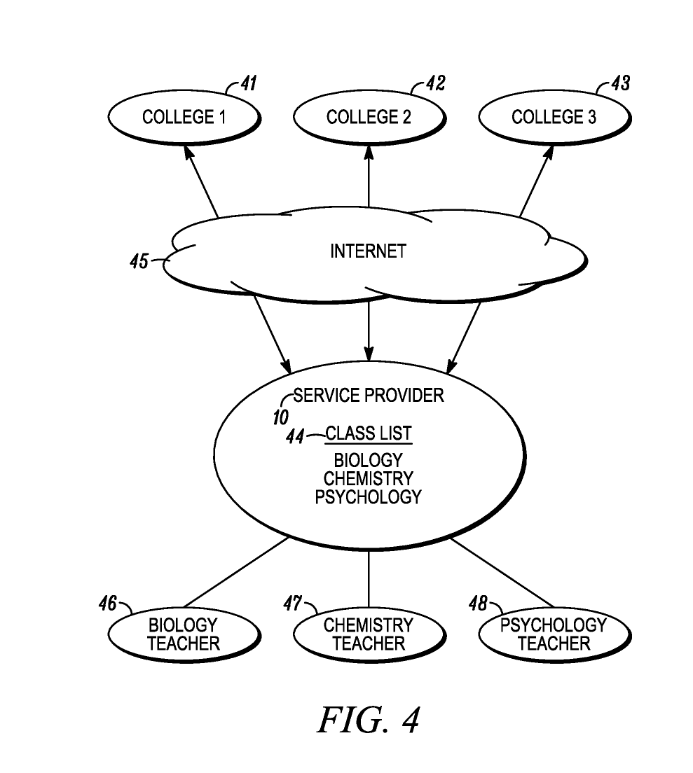

FIG. 4 diagrams the relationship between the service provider 10 and multiple colleges 41, 42 and 43. Service provider 10 has 3 courses listed on class list 44 which it posts to the internet 45 so that colleges 41, 42 and 43 can view them, sign up, and then register students for each course. In addition, the service provider 10 can use this method to provide student grades to the colleges at the end of courses. Also, as shown, is the relationship between the service provider 10 and teachers 46, 47 and 48. It is the service provider 10 that hires the teachers and thus prepares the classes and gets them ready to offer to students.

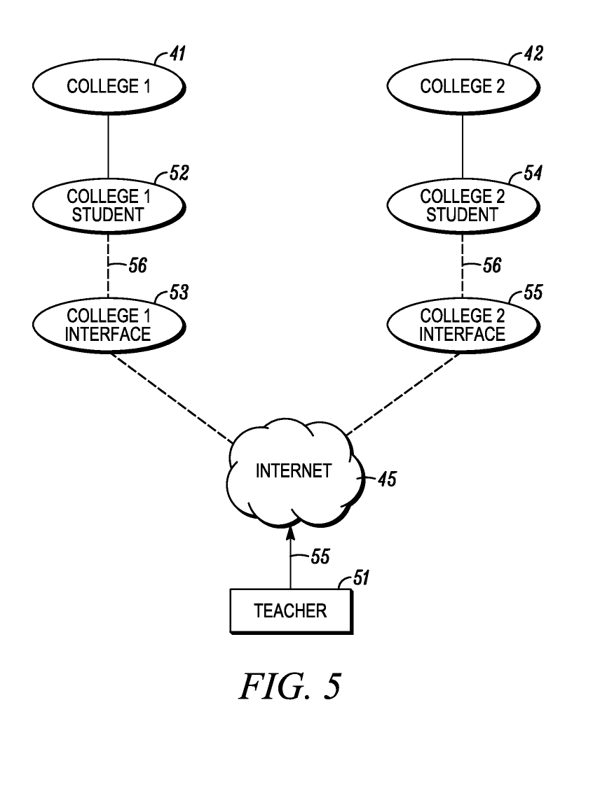

FIG. 5 depicts the relationship and part of the present invention as relates to the teacher, college and students. Teacher 51 has prepared a particular course to be given to students 52 and 54 each student in a different college 41 and 42 respectively. The teacher 51 presents a course to the internet 55 that each student 52 and 54 has signed up for. However, what each student actually sees is the college 1 53 and college 2 55 interfaces so that Students 52 and 54 receive their course in a manner that each believes they are taking the course from their respective college. The disguised relationship is depicted by dotted lines 56 in this view.

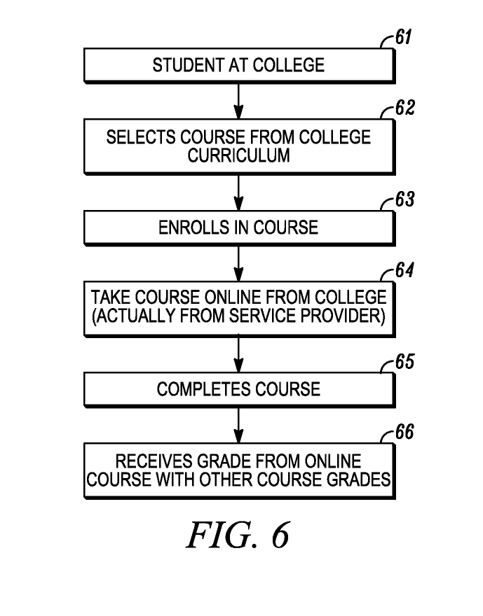

FIG. 6 depicts the present invention from the view of the student 61. Student 61 goes to the college they are attending and selects a course from the college curriculum 62. In this embodiment, the course 62 is actually a course given by service provider 10; however; since the course is shown in the course catalog; it appears for all intents and purposes to be a regular college course. The student 61 then enrolls in the course 63. The course is actually an online course and the student 61 takes the online course from what appears to be the college but wherein it is actually not 64. The student completes the course 65. Then, when the student receives the regular report card from the college, the grades from the online course appears on the report card with other course grades 66 such that the student might never be aware that the course came from other than the college.

The figures and explanations herein are not intended to be limiting. Variations in the course's systems for presentation online and the like will be evident to one skilled in the art in view of the present disclosure and that broader interpretation is intended in the claims which follow.

What is claimed is:

1. A method of providing over the internet to a plurality of colleges, a class for students in the plurality of colleges regular curriculum comprising the steps of:
a) offering a college level course from a service provider to a plurality of colleges over the internet;
b) receiving from one or more of the plurality of colleges acceptance of the course;
c) the service provider receiving information from each of the one or more of the plurality of colleges who accepted, information on the students to receive the class;
d) storing the information on the students to receive the class on at least one server computer;
e) generating the class and delivering the class to the internet;
f) providing an internet interface to each of the students in order for the student to receive the course from the internet wherein the interface each student receives indicates that the class is coming from the student's college.

2. A method according to claim 1 wherein a grade for each student receiving a class is provided to the student's respective college and the college provides the grade to the student.

3. A method according to claim 1 wherein each of the plurality of colleges must register before being allowed access to the college level course offered on the internet.

4. A system for providing a class to a plurality of colleges over the internet for inclusion in their curriculum comprising:
a) at least one server computer associated with an independent college course provider connected to the internet;
b) one or more computers associated with each of the plurality of colleges, wherein each computer connected to the internet;
wherein the at least one server computer incorporates an application for offering the class to the plurality of colleges over the internet and accepting at least one of the colleges for the course, for receiving and storing a list from the accepting colleges of the students who will take the course, and for providing the class to the list of students over the internet; and
wherein at least one of the servers is capable of presenting an interface to each student indicating the course is from the student's college.

5. A system according to claim 4 wherein the independent college course provider sends each student's grades to the colleges for distribution to each student.

6. A system according to claim 4 wherein the college courses include information regarding the teachers and the course such that the college can determine if the course complies with the college's accreditation requirements.

7. A system according to claim 4 wherein at least one server provides a means to only allow registered colleges to view the offering over the internet.

8. A system for providing one or more colleges a class for inclusion in its curriculum comprising:
a) a college course providing entity having a predefined contractual interface that specifies the terms by which a college may access a course provided by the college course providing entity; and
b) the college course providing entity functioning according to the predefined contractual interface to prepare a college course and deliver the course to the college as part of its curriculum.

9. A system according to claim 8 wherein the college course providing entity has at least one teaching agent to teach the course.

10. A system according to claim 8 wherein the contractual interface functions to provide the course to a group of students designated by the college.

11. A system according to claim 10 wherein the course is provided over the internet.

12. A system according to claim 11 wherein the course has an internet interface for the group of students that indicates that the course is from the student's college.
